(19) United States
(12) Patent Application Publication
(10) Pub. No.: US 2005/0130667 A1
(43) Pub. Date: Jun. 16, 2005

(54) Specialised mobile terminal

(75) Inventors: Gianluca Boiero, Torino (IT); Piero Lovisolo, Torino (IT); Michele Lupano, Torino (IT)

Correspondence Address: THE FIRM OF KARL F ROSS, 5676 RIVERDALE AVENUE, PO BOX 900, RIVERDALE (BRONX), NY, 10471-0900, US

(73) Assignee: TELECOM ITALIA S.P.A., Milan (IT)

(21) Appl. No.: 10/507,314

(22) PCT Filed: Mar. 11, 2003
(86) PCT No.: PCT/EP03/02476

(30) Foreign Application Priority Data
Mar. 11, 2002 (IT) TO2002 A 000204

(51) Int. Cl. H04B 17/00; H04Q 7/20

(52) U.S. Cl. 455/456.1; 455/67.11

(57) ABSTRACT

The invention refers to a specialised mobile terminal (1) intended to be localised by means of a suitable equipped telecommunications network (2). The mobile device (1) only implements the functions required for location definition and can be activated both remotely and possibly locally by the user of the device (1). The device (1) may also comprise a display to view the localisation data determined by means of the network.

### TECHNICAL FIELD

The invention refers to a specialised mobile terminal intended for use in a telecommunications network with means for localising mobile terminals on the basis of data of the predefined type transmitted by the mobile terminal.

### BACKGROUND ART

Various mobile terminal localisation systems and methods are known in the prior art. For example, international patent application published under number WO0018148 describes a method for localising mobile terminals which are cellular telephones (cell phones). According to the known method, the location of the user's cellular telephone is determined by comparing the radio-frequency data gathered by the user's cellular telephone (RF fingerprint or cell phone RF data) with RF data contained in a reference database (reference RF fingerprint), in which each RF fingerprint determines a one-to-one correspondence with an elementary area or pixel in the territory served by the network, and by assigning the position corresponding to the reference RF fingerprint whose values are closest to that of the cellular telephone.

The characterising element of this and other types of systems is that the mobile terminal to be localised physically consists of a cellular telephone mainly intended for transceiving voice and/or data communications.

As a consequence, the localisation service is essentially directed to the users of said terminals while market demands indicate the need of localisation services also for determining the location of objects, apparatuses, devices, machines and other object whereof the movements are not easily controllable beforehand.

Furthermore, the need for defining location is especially evident in contexts in which alternative location determination techniques, such as GPS (Global Positioning System) satellite systems, cannot be effectively used. Situations of this kind include, for example, the localisation of objects, devices and machines whose mobility entails access to vast urban areas or buildings and which, consequently, cannot effectively be located through satellite triangulation.

### DISCLOSURE OF THE INVENTION

Object of the invention is a specialised mobile terminal with a restricted number of functions specifically directed to permit location determination by means of a telecommunications network and which, thanks to the diffusion of said networks, can be easily located in any territorial context.

Moreover, object of present invention is a system and method for determining the location of specialised terminals under request of enabled users connected to the same network.

This object is reached by the specialised mobile terminal with means for determining location and by the system and method as claimed.

According to an additional characteristic of this invention, the mobile terminal can be either activated directly by the user of the device or remotely, for example, through a location determination centre associated to the network or by a user who is enabled to request the location of the device.

Additionally, the mobile terminal may, for example, comprise a display for viewing the position determined by the localisation centre.

### BRIEF DESCRIPTION OF THE DRAWINGS

The characteristics of the invention will now be described, by way of example only, with reference to a preferred form of embodiment and to the accompanying drawings wherein:

FIG. 1 is a diagram illustrating the architecture of a localisation system;

FIG. 2 is a logical diagram of the specialised mobile terminal according to the invention.

### BEST MODE FOR CARRYING OUT THE INVENTION

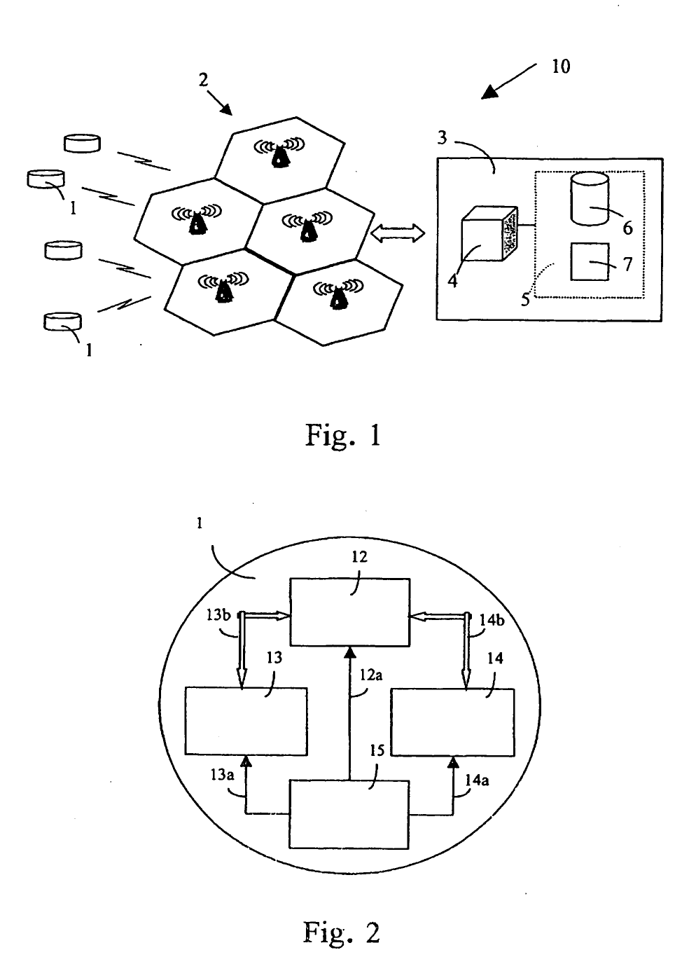

With reference to FIG. 1, a location determination system 10 according to the invention comprises a plurality of specialised mobile terminals or mobile devices (terminals) 1 randomly distributed on a certain territory and provided with the functions needed for localisation, a mobile or cellular telephone network 2, e.g. a GSM (Global System for Mobile communications) network, and a localisation centre for mobile terminals (Mobile Location Centre or MLC) 3, either associated or connected to the network 2, and able to localise either terminals 1 or cellular telephones, of the known type.

Each terminal 1 (FIG. 1 and FIG. 2) according to the invention comprises, for example, a radio-frequency input/output circuit (RF circuit) 12 having, for example, an antenna integrated therein, a controlling circuit 13 connected to the RF circuit 12 by a connection 13b and suitable for controlling the functions of the terminal 1 on the basis of programs stored in the controlling circuit 13, a SIM card (SIM) 14 connected, in known way, by a connection 14b to the circuit RF 12, and a power circuit having, for example, a battery 15 for electrically powering the circuits 12 and 13 and the SIM 14 via respective connections 12a, 13a and 14a.

The RF circuit 12, of known type, e.g. consisting of TC35 Cellular Engine data module made by Siemens, is capable of exchanging data and messages with the network 2, by means of the antenna, and with the controlling circuit 13, by means of the connection 13b, which may be a serial type connection, for example.

The RF circuit 12, according to present invention, comprises a data modem able to manage the exchange of standard signalling and/or data with the network.

The RF circuit 12 is able to measure RF field values and cell identifiers (cell ID) and to make at disposal of (transfer to) the controlling circuit 13, through the connection 13b, the RF field values measured.

According to a further embodiment of present invention, the RF circuit 12 can be specialized to collect and make at disposal of the controlling circuit 13 a number and type of RF measurement specialised for a true localisation of the terminal 1.

For example, the RF circuit 12 can be specialised, on the basis of programming modules to be stored into the RF circuit 12, in order to collect and transfer to controlling circuit 13 all the RF field values measured and the cell ID; alternatively, for example, the RF circuit 12 can comprise an antenna able to better collect RF field values.

In the preferred embodiment, the RF circuit 12 is a very light circuit as is not directed to the management of voice or multimedia information.

The controlling circuit 13, of the known type, for example consisting of a PIC16LF876A Microchip, is able of periodically collect, by means of the RF circuit 12, electromagnetic field values and cell ID (RF measurements) on the basis of programs of the known type stored, for example during the design phase, in the controlling circuit 13.

The RF measurements are determined, as known, starting from a determined number of frequency channels (channels) and selecting a maximum number of RF measurements in said channels, e.g. up to 7 according to the GSM standard; such channels correspond to an equal number of channels of which the terminal 1 is capable of decoding a respective identification code depending on the position in the territory.

According to a further embodiment, the controlling circuit 13, in order to permit a better localisation of terminal 1, can be programmed, during the design phase, to collect all the RF field values measured by the RF circuit 12.

In general, the controlling circuit 13 is able of collecting, on the basis of suitable commands remotely activated by the MLC 3 through specific signals contained, for example, in one or more SMS text messages (Short Messages), the RF measurements made by the RF circuit 12, and of transmitting them, for example in the form of SMS text messages, to the MLC 3, through the RF circuit 12.

According to an alternative or complementary form of embodiment of the invention, the commands may be activated by the terminal 1, for example, by means of a specific button or activation element, not shown in the figure, specifically arranged on the terminal 1.

According to another embodiment, the controlling circuit 13, in order to grant a long period of unattended activity of terminal 1, is able to manage commands sent by the MLC 3, through the network 2, directed to suspend the functioning of the RF circuit 12 for predetermined periods of time, e.g. minutes, hours or days.

The SIM (Subscriber Identity Module) 14 can contain, in known way, the user profile, i.e. the user identification number (IMSI, International Mobile Subscriber Identity), the services defined in the contract with the service provider and other utilities. In this form of embodiment, the user profile corresponds to that of the user of the terminal 1 and/or of a telephone user, e.g. a cellular telephone, enabled to request the location of the terminal 1.

In particular, the SIM 14 comprises, stored in protected areas, the user profile and is capable of certifying, in a known way through the connection 14b to the RF circuit 12, the possibility of exchanging messages between the MLC 3 and the terminal 1.Consequently, according to this form of embodiment, the SIM 14 ensures a high degree of protection from unauthorised or malicious use of the terminals 1. In this form of embodiment, the programs used to retrieve the measurements needed to determine location of the terminal 1, can reside in the SIM 14 and not in the controlling circuit 13.

According to a further embodiment of present invention, the user identification number can be replaced by a device identification number stored into the controlling circuit 13.

The device identification number can be associated to a user name and password in order to permit to a user connected to the network 2 through, for example, a telephone or an Internet terminal, to request the localisation of the terminal 1 by means of the MLC location centre 3.

Obviously, a single user name and password can be associated to a plurality of terminals 1.

According to such an embodiment, the network 2 or, preferably, the MLC location centre 3, comprises a data base of device identification numbers and associated user name and password in order to permit to an enabled user to request the localisation of terminal or terminals 1.

Such a data base can be a special data base directed solely for the localisation of the specialised terminal 1, as per present invention.

According to this embodiment, the network is able to recognise the device identification number of terminal 1 and to exchange standard signalling and/or data with the terminal 1 on request, for example, of the MLC location centre 3.

Obviously, the data base can be specialised by comprising either the device identification number, as above described, or the user identification number and an associated special code clearly directed to localisation services.

The network 2, in known way, is capable of receiving the RF measurements transmitted by the terminals 1 and of transmitting them to the MLC 3.

In general, the network 2 comprises a plurality of base transceiver stations and is able to support the exchange of messages and/or controlling signals between the terminals 1 and the MLC 3.

For example, the messages and/or controlling signals of terminal 1 can comprise only the typical functions of a GSM data modem.

The MLC 3, can correspond to service centres or systems and apparatuses capable of providing services employing the telecommunication network 2.

The MLC 3, of known type, comprises, for example, a computer 4, e.g. a Pentium® III twin CPU computer with RAM capacity of 512 Mbytes, a Windows® NT operating system and a subsystem of disks 5, connected to the computer 4; reference databases, as for example the data base of device identification numbers and associated user name and password, are stored in a first area 6 of the disk subsystem 5 and the modules or programs to be used for defining the position of the mobile terminals 1 are stored in a second area 7.

The MLC 3 is capable of processing the programs stored in area 7 and of identifying the position of the terminals 1 by means of said programs and on the basis both of the SMS text messages received by the terminal 1 and of the reference databases stored in area 6; moreover, the MLC 3 is able of transmitting, by means of the network 2, the resulting position data to service centres and/or to the terminals 1 and/or to the enabled user of a telephone, an Internet terminal or a service and/or to the owner of the terminal 1.

In the basic configuration, the terminal 1, object of the invention, is a small box containing electronic circuits corresponding to the minimum number of circuits needed to implement the localisation functions.

Specifically, according to this form of embodiment, the box can contain the RF circuit 12, the controlling circuit 13, the SIM 14 and the power circuit 15, as described.

According to this form of embodiment, for example, the terminal 1 may be configured not to require manual intervention by a user to be localised by means of the controlling circuit 13 it contains.

The operations concerning SMS reception, measurement retrieval, SMS transmission are carried out by employing the programs stored in the controlling circuit 13 or the SIM 14 in a sequential and automatic way following each external request or call; for example, the reception of SMS text messages from the MLC 3, by means of the network 2, to control the retrieval of measurements by the terminal 1 and the transmission of measured values to the MLC 3.

Naturally, as obvious to an expert of the sector, among other apparatuses, the network 2 may comprise a database equivalent to that used in localisation systems of the known kind, containing all the information associated to the terminals 1 (authorisations, customised profiles) which the MLC 3 can access, e.g. whenever a localisation procedure is started.

The network 2 may comprise, alternatively, the data base of device identification numbers and associated user name and password in order to grant access to the terminals 1 for their localisation.

According to the described configurations, the terminal 1 can be localised by the MLC 3 and/or by the network 2 once it is switched on, e.g. simply by inserting the battery, through a simple authentication and SMS text message exchange procedure.

For example, terminal 1 can be configured to stay in a wait or stand-by condition for waiting a call by the MLC 3 and, following the call, to reply by collecting and sending to the MLC 3 the measured values.

The position data may be made available to any external user with the required authorisation, e.g. by means of a user name and password procedure.

The basic devices and functions of the mobile terminal 1 described above are sufficient to permit the operation of the entire system 10, assuming the presence of a network 2 having associated or connected to it, a MLC 3, as described.

Moreover, further peculiarities may characterise the terminal 1.

For example, optional devices which may equip the terminal 1 are, for example, a display or visor element, to display the position calculated and sent by the MLC 3 directly to the terminal 1, a button to require location determination of the terminal 1 locally from the terminal 1 and any other accessory variant to the basic functions described above.

The operating principle of the system 10 described in the form of embodiment above consists in the use of network 2, which may also not be a GSM network.

Naturally, the controlled circuit 13 of the mobile terminal 1 may be configured to receive and transmit signal messages which comply with a generic protocol stack, such as that described in ETSI-3GPP standards, for example.

The system 10 may be constructed, as is obvious to a person skilled on the art, by employing a generic network; specifically, the localisation procedure can be adapted to a UTMS third generation network.

The use of SMS text messages for transmitting localisation commands and for the replies containing the measurements made by the terminal 1 is only one form of embodiment and may be replaced by equally efficient forms, such as, for example, RF signal transmission and/or command transmission.

According to an additional form of embodiment, obvious to a person skilled on the art, the mobile device 1 can be made to comprise solely an RF circuit comprising logical control means and a power circuit, both of the known type.

In this form of embodiment, the RF circuit comprises logical control means able to manage functions equivalent to that described with reference to the controlling circuit 13 and is capable of exchanging with the network the measurements and/or the RF signals and/or the commands for permitting localisation by the network according to one of the possible known methods.

Obvious changes and variants can be implemented to the dimensions, shapes, materials, components, circuit elements, connections and contacts in the description above, including circuit details, illustrated construction and operating method without departing from the spirit of the invention.

1. Specialised mobile terminal (1) suitable for being used in a mobile telecommunications network (2) comprising:
an RF circuit (12) capable of performing pre-determined functions and exchanging data with said network (2);
a control circuit (12, 13, 14) associated to the RF circuit {12) and able of controlling the functions of the RF circuit (12) and of exchanging data measured by said RF circuit with said network through said RF circuit (12) ; characterised in that
said control circuit (12, 13, 14) comprises control commands able
of permitting said network (2) to recognise and call the specialised terminal (1); and
of automatically transmitting to said network (2) in reply to said call the data measured in order to determine the position of the specialised terminal (1).

2. Specialised terminal (1) as per claim 1, characterised in that
said control commands of said control circuit (12, 13, 14) can be activated by means of signals transmitted by said network (2) to said mobile terminal (1) under direct control of a user terminal connected to the network (2).

3. Specialised terminal as per claim 2 characterised by a device identification number associated to the user terminal and enabled to request and automatically receive the determined position of the specialised terminal (1).

4. Specialised terminal (1) as per claim 1, characterised by
an activation element associated to the specialised Terminal (1) and capable of activating said control commands.

5. Specialised terminal (1) a per claim 4 characterised by
a displaying element associated to the specialised terminal (1) and capable of displaying the position of the specialised terminal identified by said network (2).

6. Specialised terminal (1) as per claim 1, characterised in that:
said pre-determined functions comprise the measuring of electromagnetic field and cell identifiers; and in that
said control commands comprise the transmission of messages or signals containing said electromagnetic field measurements and cell identifiers.

7. Specialised terminal (1) as per claim 1, characterised in that said control circuit (12, 13, 14) comprises at least:
a programmable logic (12, 13); and/or
an identification card, which can be programmed and associated to said specialised terminal (1).

8. System for determining the position of mobile terminals comprising
a mobile telecommunication network (2) having devices able to locate terminals; and
terminals able of exchanging data measured by the terminals with said network (2);
characterised in that
said network (2) comprises devices able to recognise and call a mobile specialised terminal (1) and determine the position of the specialised terminal (1); and in that
said specialised terminal (1) is able of automatically transmitting to said network (2) in reply to said call the data measured in order to permit said network (2) to determine the position of the specialised terminal (1).

9. System as per claim 8 characterised in that said specialised terminal (1) comprises a
device identification number associated to a user terminal connected to the network (2) and enabled to request and automatically receive the determined position of the specialised terminal (1).

10. Method for determine the position of a specialised terminal (1) connected to a mobile telecommunication network (2),
characterised by the following steps
requesting by a user terminal the position of the specialised terminal (1);
validating through said network (2) the user request,
recognising and calling on the basis of said request the specialised terminal (1); and
determining the position of the specialised terminal (1) on the basis of data measured and sent by said terminal (1) to said network (2) in reply to said call.
